(19) United States
(12) Patent Application Publication
(10) Pub. No.: US 2011/0233919 A1
(43) Pub. Date: Sep. 29, 2011

(54) COMBINATION SHIPPING SLIP/ADDRESS LABEL

(76) Inventor: Alan Edward Gieschen, Surrey (CA)

(21) Appl. No.: 12/749,249

(22) Filed: Mar. 29, 2010

(51) Int. Cl. B42D 15/00; B32B 38/10

(52) U.S. Cl. 283/79; 283/81; 283/56; 156/247

(57) ABSTRACT

The present invention relates to a shipping label that includes: a protective layer having at least a portion that is transparent; an adhesive layer connected to a side of the protective layer; and a sheet connected to the protective layer via the adhesive layer. The sheet includes a removable outer marginal portion. The protective layer has a corresponding outer marginal portion free of the sheet, after the outer marginal portion of the sheet is removed, for attaching the label to the package. The sheet includes a first inner portion containing shipping slip information arranged on a first side of the sheet to face the package. The sheet includes a second inner portion containing shipping address information arranged on the first side of the sheet. The second inner portion can be reversed front-to-back so that the shipping address information faces away from the package for displaying the shipping address information thereby.

### FIELD OF THE INVENTION

The present invention relates to a shipping label. In particular, the invention relates to a combination shipping slip/address label.

### DESCRIPTION OF THE RELATED ART

It is known per se to combine a shipping label with a shipping slip. Existing shipping labels may be in pouch form and may require that the shipping slip be foldable therewithin. In these cases the folding and unfolding of the shipping slip may be relatively time consuming for the manufacturer of the shipping label as well as the end user.

It is known to include shipping address information on one side of a shipping label and shipping slip information on the other side of the label. However such labels may require a relatively large number of parts, and/or may not be waterproof and/or may not be readily re-attachable to a shipping package. Also, there is a possibility that shipping address information may be mismatched with shipping slip information. In the alternative, such labels may require relatively complex printing equipment.

### BRIEF SUMMARY OF INVENTION

The present invention provides a shipping label disclosed herein that overcomes the above disadvantages. It is an object of the present invention to provide an improved shipping label.

There is accordingly provided a label for a package. The label includes a protective layer having at least a portion that is transparent. The label includes an adhesive layer connected to a side of the protective layer. The label includes a sheet connected to the protective layer via the adhesive layer. The sheet includes a removable outer marginal portion. The protective layer has a corresponding outer marginal portion which is free of the sheet, after the outer marginal portion of the sheet is removed, for attaching the label to the package. The sheet includes a first inner portion containing information arranged on a first side of the sheet. The sheet includes a second inner portion containing shipping address information arranged on the first side of the sheet. The first side of the sheet is disposed to face the package. The second inner portion is removable from the protective layer. The second inner portion is capable of being reversed front-to-back and re-attachable to the protective layer such that the shipping address information faces away from the package for displaying the shipping address information thereby.

According to another aspect, there is also provided a label for a package having a protective layer with at least a portion that is transparent. The label has an adhesive layer connected to a side of the protective layer. The label has a sheet connected to the protective layer via the adhesive layer. The sheet includes a removable outer marginal portion. The protective layer has a corresponding outer marginal portion which is free of the sheet, after the outer marginal portion of the sheet is removed, for attaching the label to the package. The sheet includes a first inner portion containing information arranged on a first side of the sheet. The sheet includes a second inner portion containing shipping address information arranged on the first side of the sheet. The first side of the sheet is disposed to face the package. The second inner portion is removable from the protective layer for separately attaching the second inner portion to the package and displaying the shipping address information thereby.

There is further provided, in combination, a shipping label for a shipping package and a business card for connecting to the shipping label. The label includes a protective layer having at least a portion that is transparent. The label includes an adhesive layer connected to a side of the protective layer. The label includes a sheet connected to the protective layer via the adhesive layer. The sheet includes a removable outer marginal portion. The protective layer has a corresponding outer marginal portion which is free of the sheet, after the outer marginal portion of the sheet is removed, for attaching the label to the package. The sheet has a first inner portion containing information arranged on a first side of the sheet. The first side of the sheet is disposed to face the shipping package. The sheet has a removable second inner portion shaped to accommodate the business card. The portion of the protective layer that is transparent is free of the sheet, after the second inner portion of the sheet is removed, for attaching the business card thereon.

There is yet further provided a method of forming a shipping label for a shipping package. The method includes providing a sheet having a first side for facing the package and a second side opposite the first side. The method includes printing shipping slip information and shipping address information on the first side of the sheet. The method includes separating the sheet into a removable outer marginal portion, a first inner portion containing the shipping slip information and a second inner portion containing shipping address information. The method includes connecting a protective layer to the second side of the sheet via an adhesive. The protective layer has at least a portion that is transparent. The protective layer has an outer marginal portion which is free of the sheet, after the outer marginal portion of the sheet is removed, for attaching the label to the package. The method includes configuring the second inner portion of the sheet to be removable from the protective layer. The method includes removing the second inner portion from the protective layer, reversing front-to-back the second inner portion, and re-connecting the second inner portion to the protective layer such that the shipping address information faces away from the package for displaying the shipping address information thereby.

### BRIEF DESCRIPTION OF DRAWINGS

The invention will be more readily understood from the following description of preferred embodiments thereof given, by way of example only, with reference to the accompanying drawings, in which:

FIG. 1 is a front perspective view of a shipping label, according to one embodiment;

FIG. 2 is a fragmentary side perspective view of the shipping label shown in FIG. 1 illustrating the different layers of the label;

FIG. 3 is a rear perspective view of the shipping label shown in FIG. 1;

FIG. 4 is a rear perspective view of the shipping label shown in FIG. 1 with an outer marginal portion removed and a second inner portion in the process of being removed and reversed front-to-back;

FIG. 5 is a front perspective view of the shipping label shown in FIG. 1 with the second inner portion now flipped around;

FIG. 6 is a front, top perspective view of the shipping label in the mode shown in FIG. 5 as attached to a shipping package;

FIG. 7 is a rear perspective view of a shipping label similar to that shown in FIG. 1 according to another embodiment, with a second inner portion and a third inner portion both in the process of being removed and reversed front-to-back;

FIG. 8 is a front perspective view of the shipping shown in FIG. 7 with the second inner portion and the third inner portion now flipped around;

FIG. 9 is a rear perspective view of a shipping label similar to that shown in FIG. 1 according to a further embodiment, with a second inner portion in the process of being removed;

FIG. 10 is a front perspective view of the shipping shown in FIG. 9 with a business card in the place of the second inner portion, attached to a portion of a protective layer that is transparent;

FIG. 11 is a rear perspective view of a shipping label similar to that shown in FIG. 1 according to a yet further embodiment, with a second inner portion in the process of being removed and reversed front-to-back and a third inner portion in the process of being removed;

FIG. 12 is a front perspective view of the shipping label shown in FIG. 11, with the second inner portion now flipped around and a business card in the place of the third inner portion, attached to a portion of a protective layer that is transparent;

FIG. 13 is a rear perspective view of a shipping label according to yet another embodiment with a first part and a second part detachably connected to the first part, and the second part of the label having a second inner portion in the process of being removed; and

FIG. 14 is a front, top perspective view of the shipping label shown in FIG. 13 with the first part of the label attached to a shipping package and the second inner portion of the second part of the label separately attached to the shipping package.

### DESCRIPTION OF THE PREFERRED EMBODIMENTS

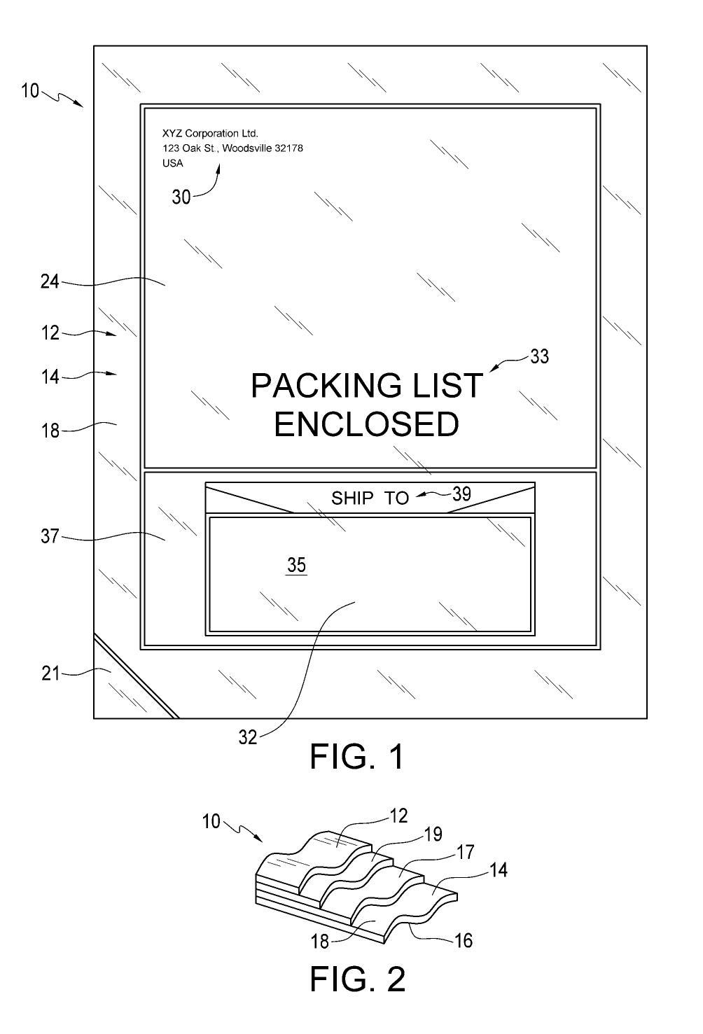

Referring to FIG. 1, there is provided a label, in this example a shipping label 10. FIG. 1 shows a front perspective view of the label 10. The shipping label 10 includes a protective layer 12. The protective layer 12 has at least a portion that is transparent, and in this example, the layer 12 is completely transparent. The protective layer 12 in one preferred embodiment is clear polypropylene 70 microns, though those skilled in the art will appreciate that other materials may be used. The protective layer 12 is thus made of a waterproof material. The protective layer 12 in this example extends completely across the side of the label 10 shown in FIG. 1.

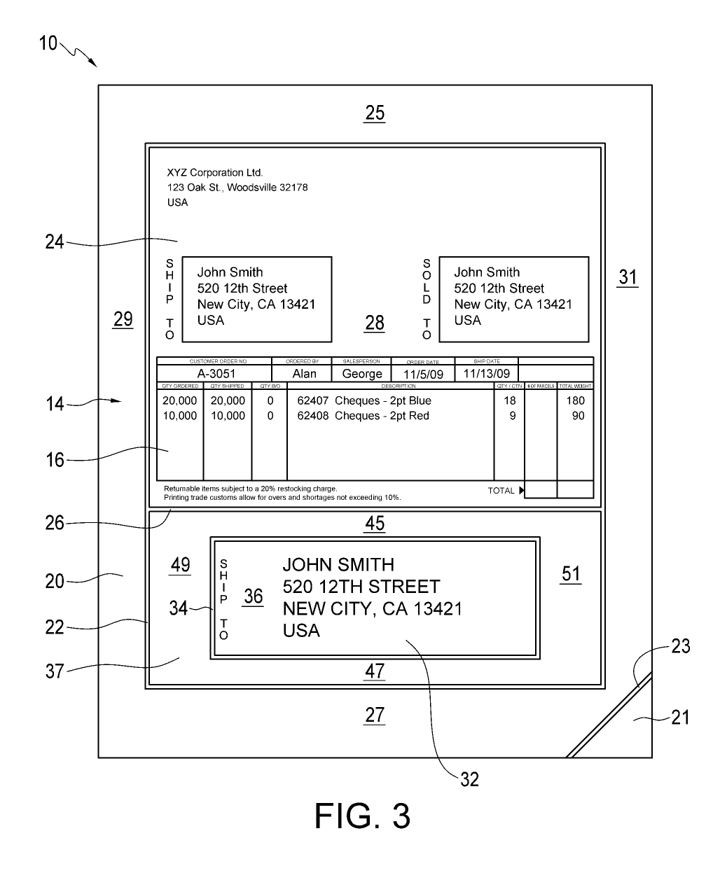

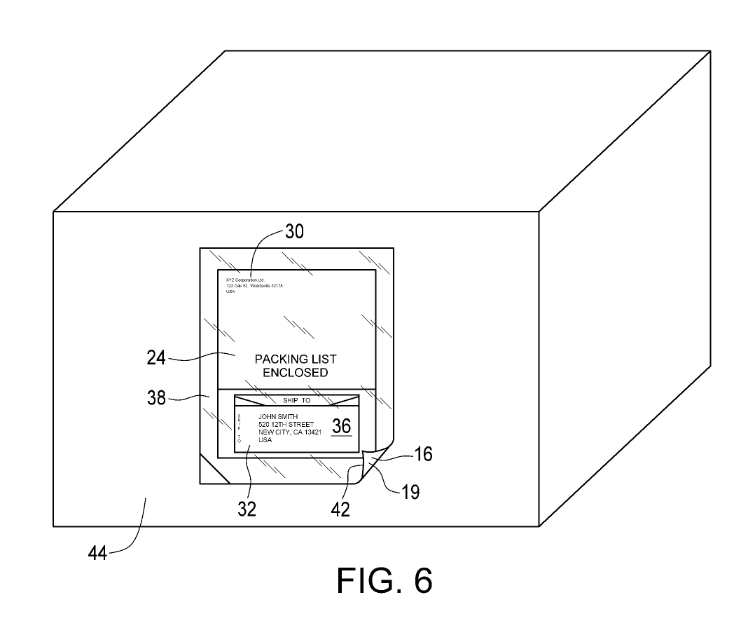

FIG. 3 shows a rear perspective view of the label 10. The shipping label 10 also includes a sheet 14 as best shown in FIG. 3. The sheet 14 in one preferred embodiment is a direct thermal sheet of paper 5 pts, though those skilled in the art will appreciate that other materials may be used. The sheet 14 in this example extends completely across the side of the label 10 shown in FIG. 3. Referring to FIG. 2, the sheet 14 has a first side 16 for facing in this example a shipping package 44, as shown in FIG. 6. The sheet 14 has a second side 18 opposite the first side 16.

Still referring to FIG. 2 the shipping label 10 includes an adhesive layer 19. The adhesive layer 19 in one preferred embodiment is a hot melt/permanent adhesive. The adhesive layer 19 is coated across one side of the protective layer 12 in this embodiment. The shipping label 10 is configured to enable the sheet 14 to be removable and re-attachable to the protective layer 12 and in one preferred embodiment this is enabled via a free radical silicone layer 17. The free radical silicone layer 17 is coated across and on the second side 18 of the sheet 14 in this embodiment. The sheet 14 is thus connected to the protective layer 12 via the free radical silicone layer 17 and the adhesive layer 19, respectively. The second side 18 of the sheet 14 thus faces the protective layer 12. The free radical silicone layer 17 is configured to enable the sheet 14 to be removable from and re-attachable to the adhesive layer 19 and thus the protective layer 12.

The technology relating to adhesives and layers that allow objects to be removable, re-attachable and/or replaceable is known per se and therefore will not be described in further detail. In this regard those skilled in the art will appreciate that other materials may be used to the same or similar effect.

As best shown in FIG. 3, the sheet 14 includes a removable outer marginal portion 20. The marginal portion 20 is formed by separating, in this example cutting, the sheet 14 along a rectangular, outer cut-out 22. Cut-out 22 and all other cut-outs referred to in this description are shown in the drawings with a relatively exaggerated spacing for the sake of clarity. There need not be any spacing between cut-out portions of the sheet 14, and preferably, there is little or no significant spacing between cut-out portions of the sheet 14.

The marginal portion 20 includes a top 25 and a bottom 27 opposite the top 25. The marginal portion 20 includes a first side 29 which is on the left from the perspective of FIG. 3. The marginal portion 20 includes a second side 31 opposite the first side 29. The second side 31 is on the right from the perspective of FIG. 3.

The sheet 14 includes a peel tag 21 adjacent to the marginal portion 20. In this example the peel tag 21 is formed by separating a triangular portion from the marginal portion 20 via a diagonal cut-out 23. The peel tag 21 in this example is disposed adjacent to both the bottom 27 of the marginal portion 20 and the second side 31 of the marginal portion 20, though is not required.

The sheet 14 includes a first inner portion 24. The first inner portion 24 in this example is disposed adjacent to the top 25 and sides 29 and 31 of the marginal portion 20. The first inner portion 24 contains information, such as private information and in this example, shipping slip information 28 on the first side 16 of the sheet 14. Alternatively the information may be, for example, invoice information or customs information. Referring to FIG. 1, the first inner portion 24 may also include indicia such as in this example return address shipping information 30 printed on the second side 18 of the sheet 14. Alternatively the indicia may for example be or further include advertising indicia. The first inner portion 24 also includes the printed marking “PACKING LIST ENCLOSED” 33 on the second side 18 of the sheet 14, though this alternatively may state for example “INVOICE ENCLOSED” or “CUSTOMS FORM ENCLOSED”.

Referring back to FIG. 3, the sheet 14 includes a second inner portion 32 and a peripheral portion 37. The peripheral portion 37 and the second inner portion 32 are disposed below the first inner portion 24, from the perspective of FIG. 3. The peripheral portion 37 is separated from the first inner portion 24 via cut-out 26. The peripheral portion 37 is disposed adjacent to the bottom 27 and sides 29 and 31 of the marginal portion 20.

The peripheral portion 37 includes a top 45 adjacent to the cut-out 26. The peripheral portion 37 includes a bottom 47 opposite the top 45 and adjacent to the bottom 27 of the marginal portion 20. The peripheral portion 37 has a first side 49 adjacent to the first side 29 of the marginal portion 20. The first side 49 is to the left from the perspective of FIG. 3. The peripheral portion 37 has a second side 51 opposite the first side 49 and adjacent to the second side 31 of the marginal portion 20. The second side 51 is to the right from the perspective of FIG. 3. Referring to FIG. 1, the peripheral portion 37 in this example includes the printed marking “SHIP TO” 39 on the second side 18 of the sheet 14.

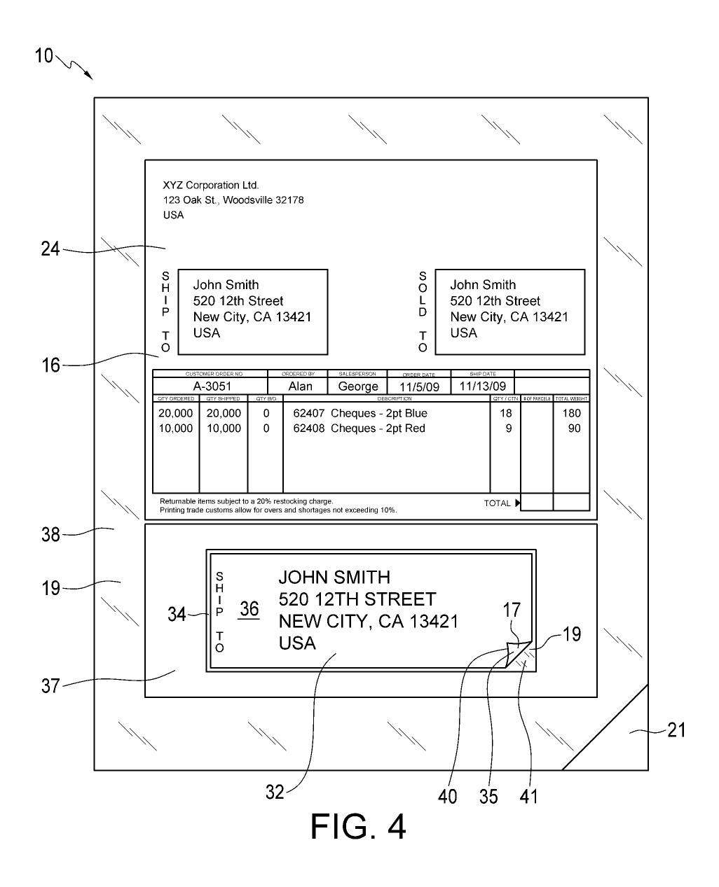

The second inner portion 32 as shown in FIG. 3 is rectangular in shape in this example. The second inner portion 32 is formed via rectangular cut-out 34. The second inner portion 32 borders and is adjacent to the top 45, bottom 47, and sides 49 and 51 of the peripheral portion 37. The second inner portion 32 includes shipping address information 36 printed on the first side 16 of the sheet 14. Referring to FIG. 1, the second inner portion 32 in this example is blank on side 35, which in this mode corresponds to the second side 18 of the sheet 14. Side 35 of the second inner portion 32 is coated with the free radical silicone layer 17, as shown in FIG. 4, to enable the second inner portion 32 to be removable from the protective layer 12.

The manner in which the shipping label 10 is applied to the shipping package will now be described. Referring to FIGS. 1 and 4, the peel tag 21 is gripped by the user and pulled upwards and towards the right, from the perspective of FIG. 1. This causes the outer marginal portion 20 to be removed from the label 10, as shown in FIG. 4. After the outer marginal portion 20 is removed, a corresponding outer marginal portion 38 of the protective layer 12 is free from the sheet 14. The outer marginal portion 38 of the protective layer 12 has a shape generally corresponding to that of the marginal portion 20 of the sheet 14. The marginal portion 38 continues to have the adhesive layer 19 connected thereto.

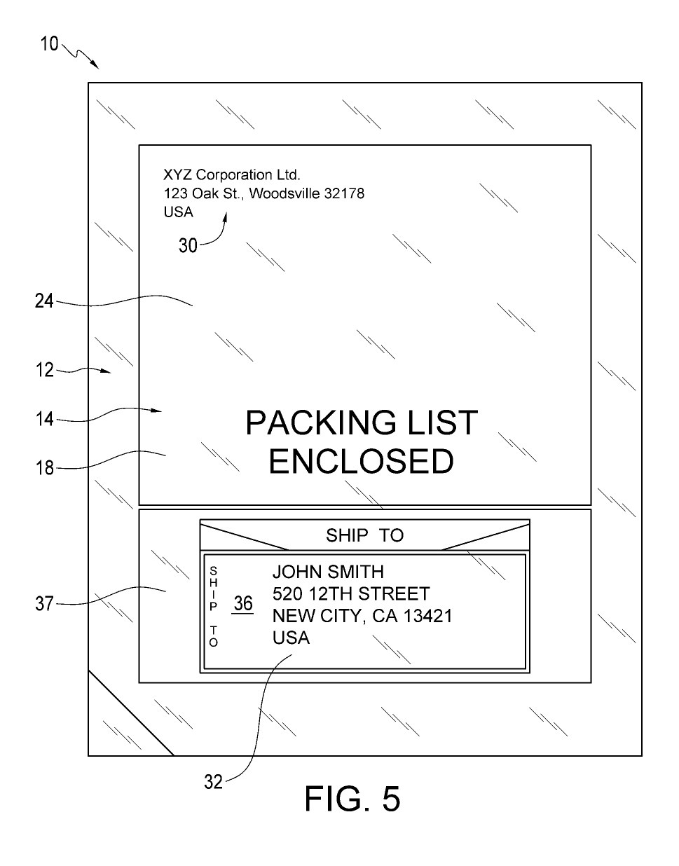

The second inner portion 32 is then removed from the protective layer 12 by peeling it away from the protective layer 12 via corner 40. A rectangular portion 41 of the protective layer 12 bearing the adhesive layer 19 is exposed as a result. The rectangular portion 41 extends between the top 45, bottom 47, and sides 49 and 51 of the peripheral portion 37 shown in FIG. 3. The second inner portion 32 is then reversed front-to-back or, put another way, flipped around. The second inner portion 32 is next re-attached to the portion 41 such that the shipping address information 36 is now arranged to face away from the shipping package, as shown in FIG. 5. The second inner portion 32 so configured now connects directly with the adhesive layer which in turn connects directly to the protective layer 12. Thus in this embodiment the second inner portion 32 may no longer be readily removable from the protective layer 12.

Referring to FIG. 6, the shipping label 10 so configured is then attached to the shipping package 44 via adhesive on the outer marginal portion 38. The shipping label 10 thus displays shipping address information 36 and return shipping address information 30 on a side facing away from the shipping package 44. The shipping label 10 is also readily removable via corner 42 to reveal the shipping slip information 28 contained on the side 16 of the sheet 14 facing the shipping package 44. The first inner portion 24 containing the shipping slip information 28 may also next be fully removed from the protective layer 12 of the label 10 for safe keeping if this is desired by the user.

Many advantages result from the structure of the present invention. For example, the shipping label 10 as herein disclosed, with its second inner portion 32 that is configured to be reversed front-to-back, provides the advantage of enabling all relevant information to be printed on a single side of the sheet 14, in this example side 16. This may lead to increased efficiency in the manufacture of such labels. Moreover, by enabling all relevant information to be printed on a single side of the sheet, this may act to reduce costly errors resulting, for example, from mismatching shipping addresses and shipping slip information.

By providing a shipping label 10 employing a single sheet 14 having information on both sides, the shipping label 10 provides further advantages. It may be more efficient to read the shipping slip information 28 since this can be done by merely removing the label 10. This is in contrast to labels of the prior art, which may require the shipping slip information to be first unfolded.

The shipping label 10, with its sheet 14, free radical silicone layer 17, adhesive layer 19 and protective layer 12, is very compact and may require fewer parts compared to labels of the prior art. The shipping label 10 may use less material compared to shipping labels of the prior art, because for example it may employ a single sheet 14 with information on one or both sides, rather than for example a sheet that is folded upon itself. This may provide economic savings, reduce weight and reduce bulk.

Because of the adhesive layer 19, the shipping label 10 may also be at least partially re-attachable to the shipping package 44 via parts of adhesive on the outer marginal portion 38 that are not covered by shipping package material. The shipping label 10 may thus be removable and re-usable for re-applying the shipping label 10 to the or another shipping package.

Put another way, the shipping label 10 provides a compact solution where advantageously, for printing and locating purposes, all of the shipping slip and address information is printed on one side of a sheet. This may reduce steps and reduce errors that may otherwise arise when shipping address and shipping slip information are on separate labels. The flipping aspect of the invention as herein described provides a synergy because it combines the simplicity and compactness of printing all of the relevant information on one side of the sheet 14 with the ability to then selectively reveal some of this information via the other side of the sheet 14.

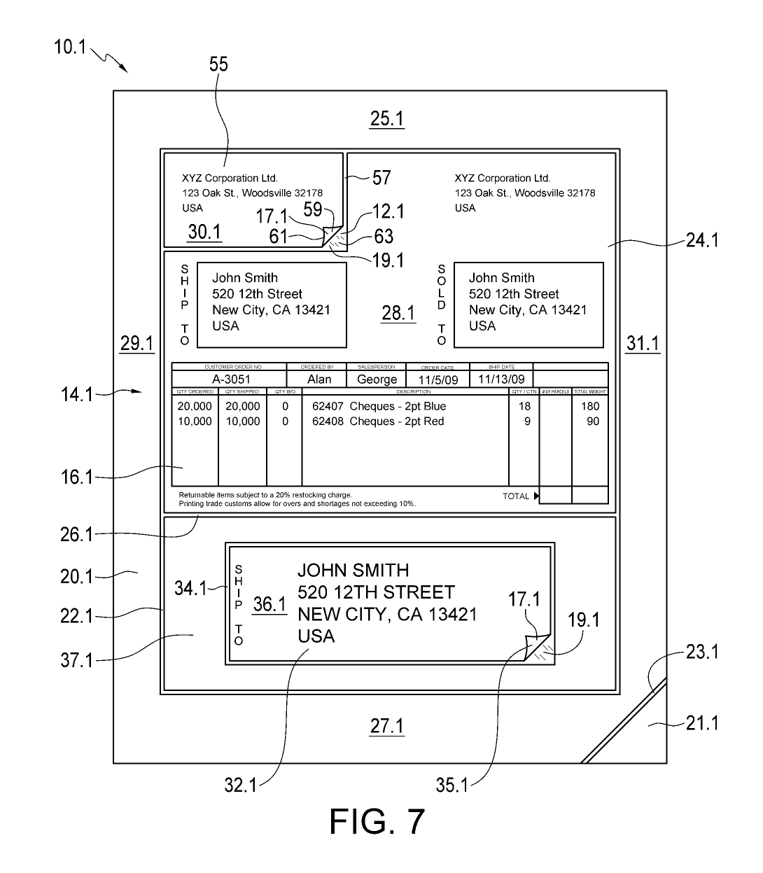

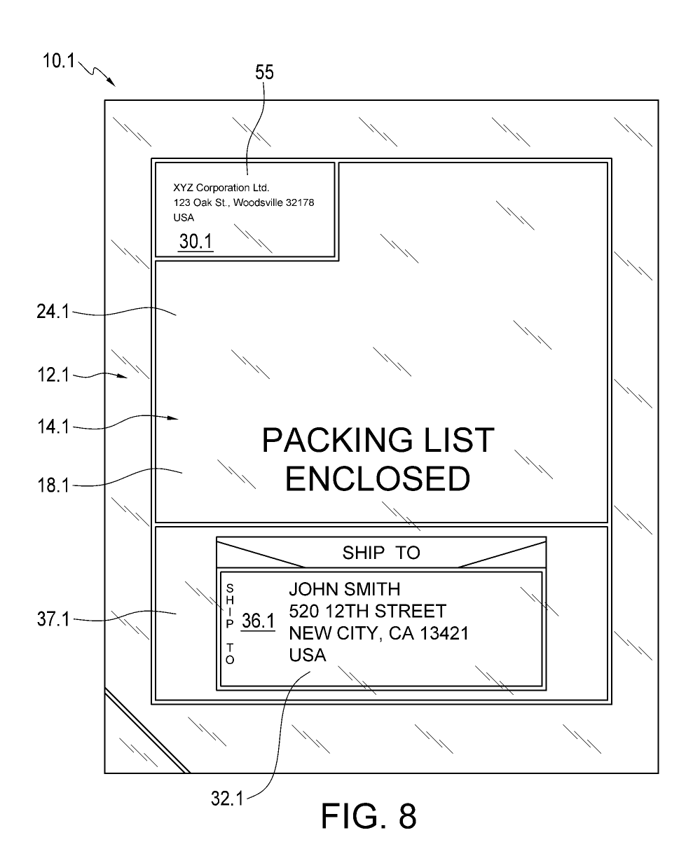

Referring to FIGS. 7 and 8, a shipping label 10.1 according to another embodiment is shown. Like parts have like numbers and function with the addition of “0.1”. FIG. 7 shows the shipping label 10.1 from a rear perspective view. The shipping label 10.1 is similar to that shown in FIGS. 1 to 6 with the exception that the sheet 14.1 further includes a third inner portion 55.

The third inner portion 55 of the sheet 14.1 is formed via cut-out 57 and in this example is rectangular in shape. The third inner portion 55 is located in a top left corner, from the perspective of FIG. 7, in this example. The third inner portion 55 borders with the marginal portion 20.1 and is adjacent to the top 25.1 and the side 29.1 of the marginal portion 20.1. In this embodiment the return address shipping information 30.1 is printed on the third inner portion 55 on the first side 16.1 of the sheet 14.1. The third inner portion 55 in this example is blank on side 59, which in this mode corresponds to the second side 18.1 of the sheet 14.1. Side 59 of the third inner portion 55 is coated with the free radical silicone layer 17.1.

In applying the label 10.1 to a shipping package, the third inner portion 55 may be removed by peeling it off from the protective layer 12.1 via corner 61 to reveal a corresponding inner portion 63 of the protective layer 12.1 which includes the adhesive layer 19.1. The third inner portion 55 is then reversed front-to-back. The third inner portion 55 is next re-attached to the portion 63 such that the return address shipping information 30.1 is now arranged to face away from the shipping package, as shown in FIG. 8. In a similar manner the second inner portion 32.1 is also reversed front-to-back to face away from the shipping package, as shown in FIG. 8, in the manner described for the embodiment shown in FIGS. 1 to 6.

Thus for the shipping label 10.1, advantageously for printing and locating purposes, all of the shipping slip information 28.1, shipping address information 36.1 and return shipping address information 30.1 is printed on one side of a sheet. This may further reduce errors that may otherwise arise when shipping slip information, shipping address information and return shipping address information are on separate labels. Here too flipping aspect of the invention as herein described provides a further synergy because it combines the simplicity and compactness of printing even more of the relevant information on just one side of the sheet 14.1 with the ability to then selectively reveal some of this information via the other side of the sheet 14.1.

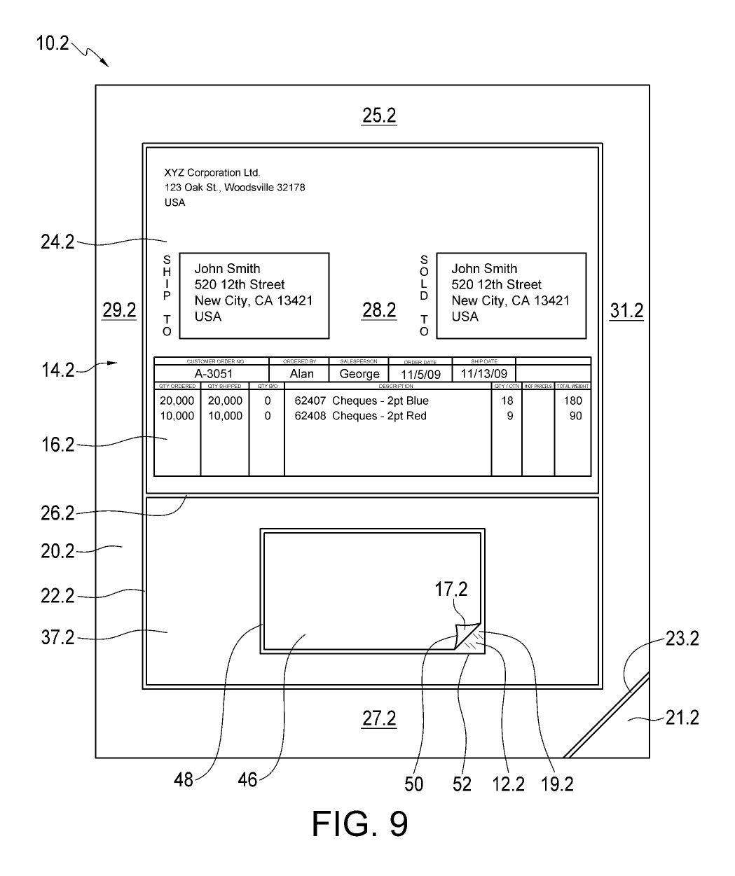

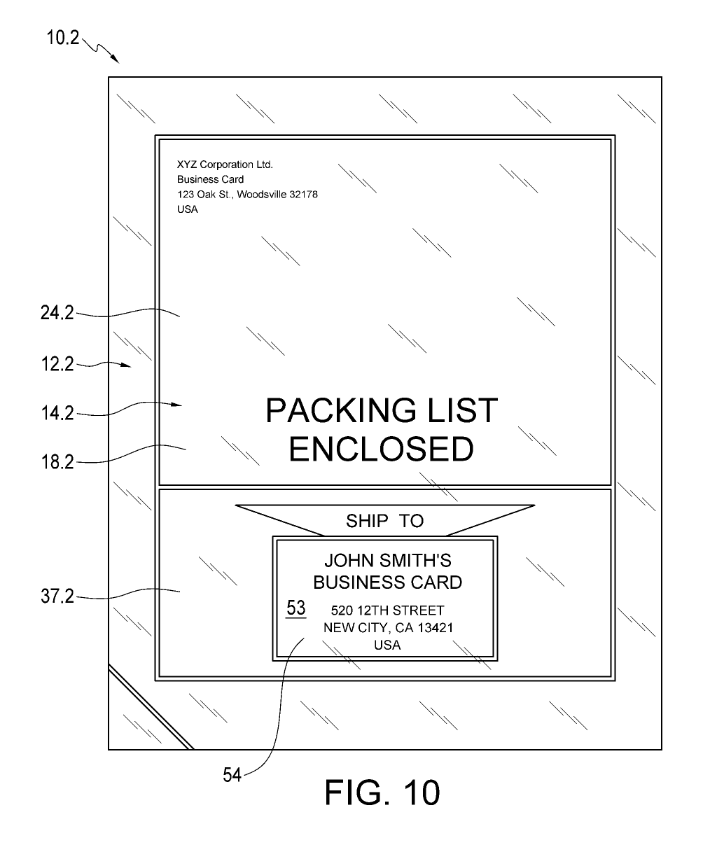

Referring to FIGS. 9 and 10, a shipping label 10.2 according to another embodiment is shown. Like parts have like numbers and function with the addition of “0.2”. FIG. 9 shows the shipping label 10.2 from a rear perspective view. The shipping label 10.2 provides a second inner portion 46 that is blank on both of its sides. The second inner portion 46 takes the place of the second inner portion 32 shown in FIGS. 1 and 3 to 6. The second inner portion 46 is formed via rectangular cut-out 48. The second inner portion 46 in this example is rectangular in shape, and preferably in the shape of a business card. The second inner portion 46 is coated with the free radical silicone layer 17.2, which enables the second inner portion 46 to be removed by peeling it off from the protective layer 12.2 via corner 50. This reveals a corresponding inner rectangular portion 52 of the protective layer 12.2 which includes the adhesive layer 19.2. The inner rectangular portion 52 of the protective layer 12.2 thus has a shape generally corresponding to a business card in this example.

A business card 54 may then be attached to the inner portion 52, as shown in FIG. 10, which shows the label 10.2 in a front perspective view. In this example the business card 54 has printed on it indicia including address information 53 that may be used for shipping purposes. In all other respects the shipping label 10.2 is similar to that shown in FIGS. 1 to 6.

The shipping label 10.2 thus provides added versatility in enabling a business card to be incorporated into the label. This may save time in some circumstances or be more convenient in circumstances where, for example, business cards are readily available. The shipping label 10.2 may also provide the advantage of providing the end user with the ability to better customize their shipping labels by incorporating their own business cards therewith.

In a variation, the second inner portion 32 and/or the peripheral portion 37 may be removed from the protective layer 12 of the shipping label 10, shown in FIGS. 1 and 3 to 6, for the placement of a business card.

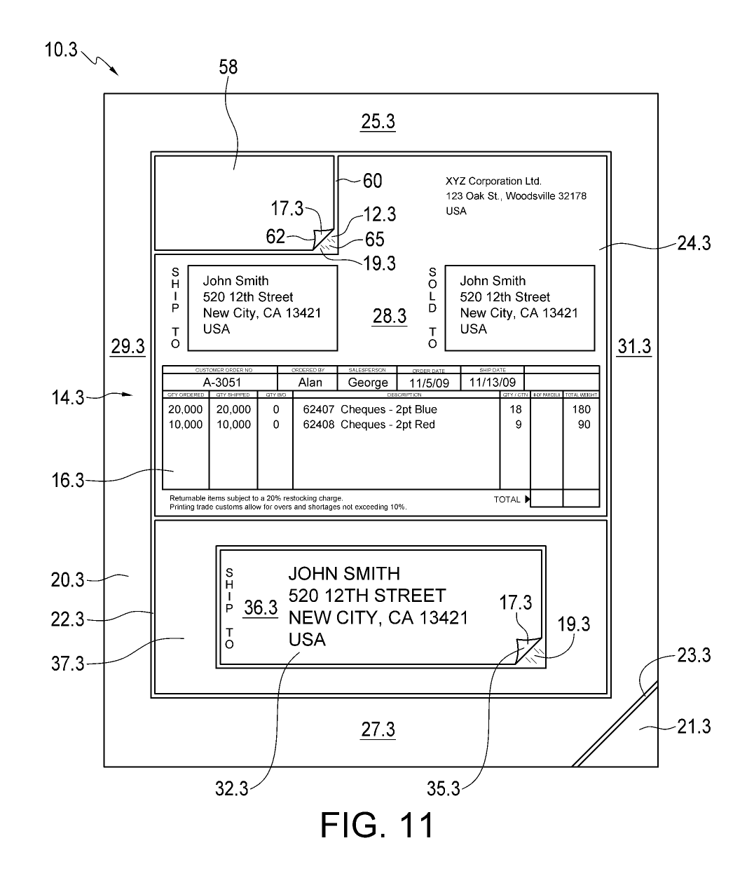

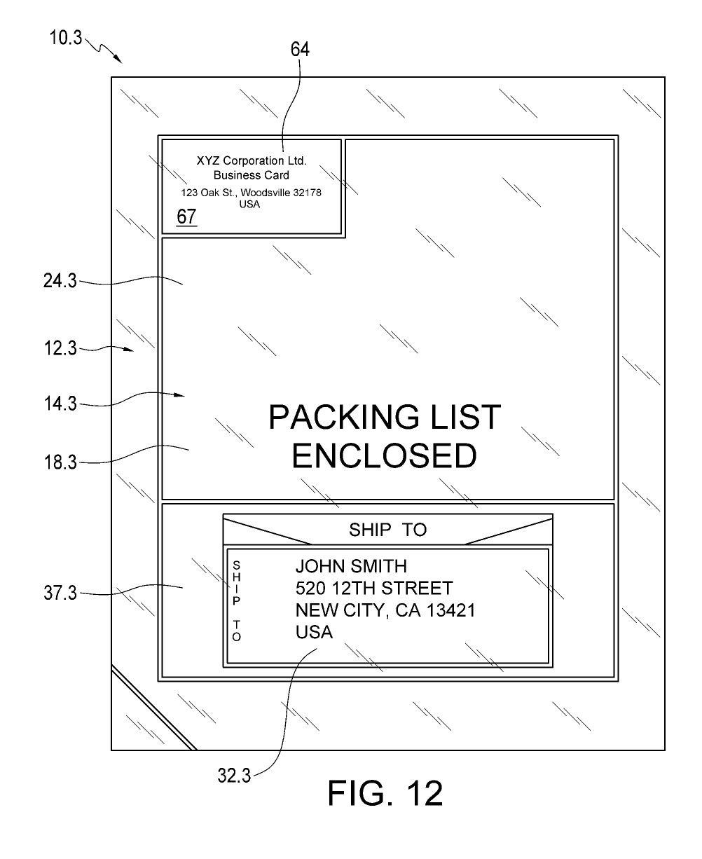

Referring to FIGS. 11 and 12, a shipping label 10.3 according to a yet further embodiment is shown. Like parts have like numbers and function with the addition of “0.3”. FIG. 11 shows a rear perspective view of the shipping label 10.3. The shipping label 10.3 is similar to that shown in FIGS. 1 to 6 with the exception that the sheet 14.3 further includes a third inner portion 58.

The third inner portion 58 is formed via cut-out 60 and in this example is rectangular in shape, preferably in the shape of a business card. In this example the third inner portion 58 is located in a top left corner, from the perspective of FIG. 11. The third inner portion 58 in this example borders with the marginal portion 20.3 and is adjacent to the top 25.3 and the side 29.3 of the marginal portion 20.3. The third inner portion 58 is coated with the free radical silicone layer 17.3 to enable it to be removed by peeling it off from the protective layer 12.3 via corner 62. This reveals a corresponding inner portion 65 of the protective layer 12.3 which includes the adhesive layer 19.3. The corresponding inner portion 65 of the protective layer 12.3 thus has a shape generally corresponding to a business card.

A business card 64 may then be attached to the inner portion 65, as shown in FIG. 12, which is a front perspective view of the label 10.3. The business card 64 has indicia which in this example includes address information 67 that may be used for shipping purposes. In all other respects the shipping label 10.3 is similar to that shown in FIGS. 1 to 6.

The shipping label 10.3 may thus provide the added versatility of enabling a business card to be incorporated within its configuration, for use, for example, in displaying return address shipping address information. It also provides the advantage of enabling the end user to better customize their shipping labels in a convenient manner.

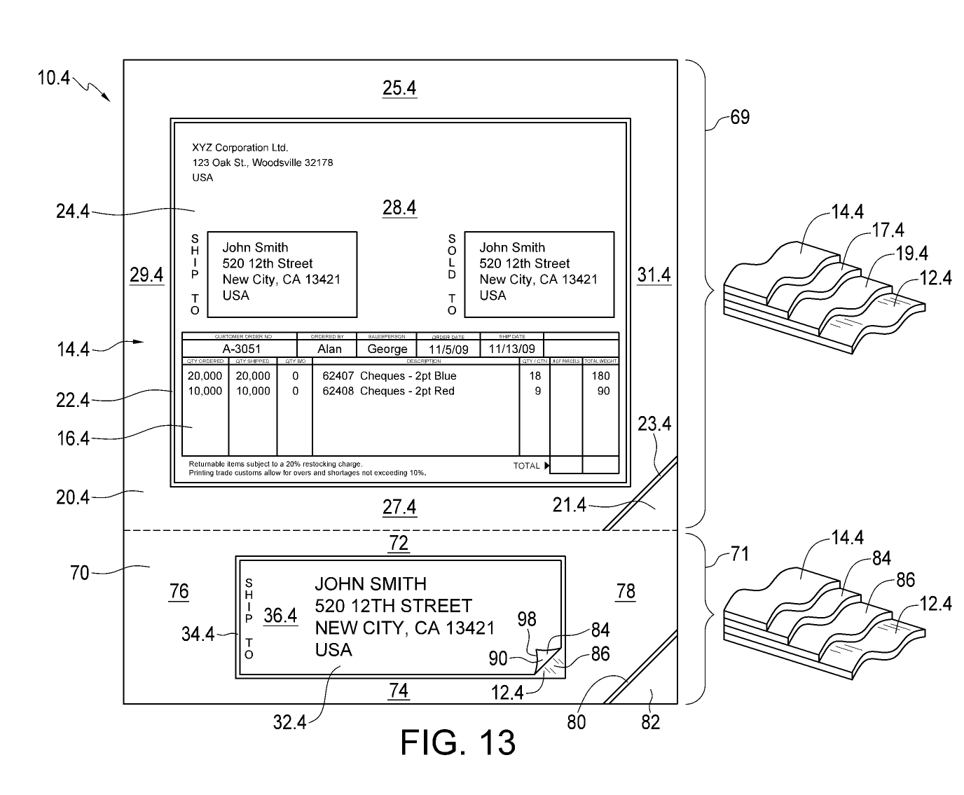

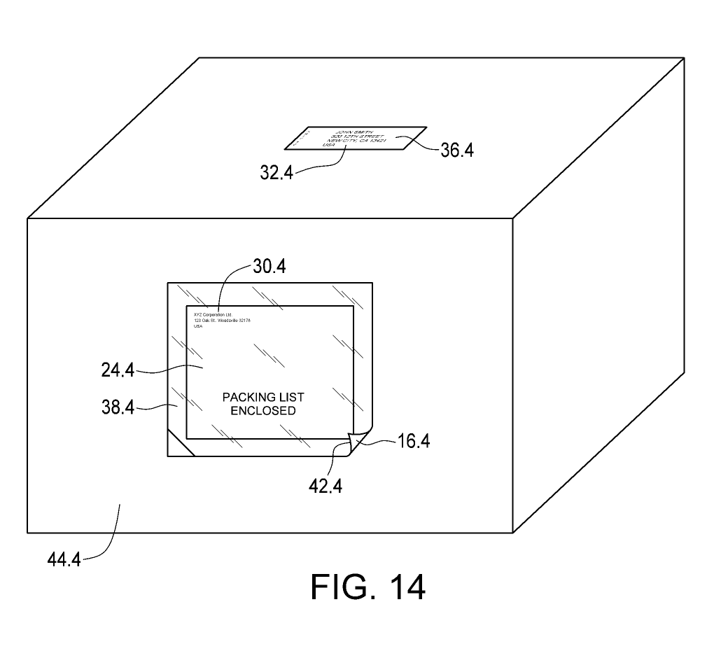

FIGS. 13 and 14 show a shipping label 10.4 according to a yet another embodiment. Like parts have like numbers and function with the addition of “0.4”. The label 10.4 includes a first part 69 and a second part 71 abutting the first part 69. The first part 69 includes the outer marginal portion 20.4 and the first inner portion 24.4. In this embodiment the outer marginal portion 20.4 extends around only the first inner portion 24.4. A free radical silicone layer 17.4 coats the area of the sheet 14.4 comprising the outer marginal portion 20.4 and the first inner portion 24.4. An adhesive layer 19.4 coats the corresponding protective layer 12.4. Put another way, the area of the protective layer 12.4 that faces opposite the first inner portion 24.4 and the outer marginal portion 20.4 is in contact with the adhesive layer 19.4. This configuration is the same as that described for the previous embodiments: the outer marginal layer 20.4 is removable and the first inner portion 24.4 is removable and re-attachable to the adhesive layer 19.4 because of the coating of the free radical silicone layer 19.4.

The second part 71 of the label 10.4 includes a peripheral portion 70 and the second inner portion 32.4. The peripheral portion 70 has a top 72 adjacent to the bottom 27.4 of the outer marginal portion 20.4. The peripheral portion 70 has a bottom 74 opposite the top 72. The peripheral portion 70 has a first side 76 that is to the left, from the perspective of FIG. 13. The peripheral portion 70 has a second side 78 opposite the first side 76. The second side 78 of the peripheral portion 70 is to the right, from the perspective of FIG. 13.

In this embodiment the second part 71 of the label 10.4 is detachable from the first part 69 of the label 10.4. In particular perforations 79 separate the bottom 27.4 of the outer marginal portion 20.4 from the top 72 of the peripheral portion 70, in this example.

For the second part 71 of the label 10.4, an adhesive layer 84 coats the sheet 14.4., namely, the second inner portion 32.4 of the sheet 14.4 and, in this example, the peripheral portion 70, though this is not required. The adhesive layer 84 in a preferred embodiment is a hot melt/permanent adhesive. A free radical silicon layer 86 coats the area of the protective layer 12.4 that faces the peripheral portion 70 and the second inner portion 32.4. Put another way, a free radical silicon layer 86 coats the area of the protective layer 12.4 disposed at the second part 71 of the label 10.4.

To apply the label 10.4, the second inner portion 32.4 is peeled away from the protective layer 12.4. This may be accomplished by peeling away corner 88 to reveal side 90 of the second inner portion 32.4. Side 90 of the second inner portion 32.4 is coated with the adhesive layer 84. The second inner portion 32.4, with its adhesive layer 84, may next be applied to the shipping package 44.4, as shown in FIG. 14. The peripheral portion 70 may be detached from the first part 69 of the label 10.4, though this is not required. The outer marginal portion 20.4 is peeled away from the protective layer 12.4 to reveal a corresponding portion of the protective layer 12.4 with adhesive coated thereon and that is free from the sheet 14.4. The first part 69 of the label 10.4 may then be attached to the shipping package 44.4 on an area of the shipping package 44 that may be separate or spaced-apart from the second inner portion 32.4.

Those skilled in the art will appreciate that for any of the above embodiments, the peripheral portion 37 is not required. For example and referring to FIG. 3, the second inner portion may be enlarged and so shaped so as to abut cut-out 26 and be directly adjacent to the first inner portion 24 and the bottom 27 and sides 29 and 31 of the marginal portion 20.

In the preferred embodiments described herein the sheet 14 is a direct thermal sheet of paper. Printing devices use heat to print an image (for example desired information) on the direct thermal sheets with the advantage being that the replacement of parts and maintenance is reduce compared to traditional printing devices. For example with direct thermal sheets the user need not continually change printing ribbons. However in the alternative the sheet 14 for example may be a photocopy sheet, with printing ribbons employed to stamp on (or print) desired information.

While in the description mention is made of coating either the sheet 14 or protective layer 12 with either the adhesive layer or free radical silicon layer, the sheet 14 and protective layer 12 may alternatively have sporadic or spot coating.

For the second part 71 of the label 10.4 shown in FIGS. 13 and 14, it is only the second inner portion 32.4 of the sheet 14.4 that need be coated with the adhesive layer 84 and the corresponding area of the protective layer 12.4 that requires coating with the free radical silicone layer 86.

The second inner portion 32.4 may be arranged in another configuration along the label 10.4. For example, the second part 71 may be omitted altogether and the second inner portion 32.4 may be disposed somewhere in the first part 69 with spot reverse layering—that is coating of adhesive onto only the second inner portion 32.4 and corresponding coating of free radical silicon only on the corresponding protective layer 12.4, as required. This may be arranged with two silicone application stations on the press. Each station may apply the silicone to the areas required on each sheet.

It will be understood by someone skilled in the art that many of the details provided above are by way of example only and are not intended to limit the scope of the invention which is to be determined with reference to the following claims.

What is claimed:

1. A label for a package comprising:
a protective layer having at least a portion that is transparent;
an adhesive layer at least partially connected to a side of the protective layer; and
a sheet connected to the protective layer via the adhesive layer, the sheet including a removable outer marginal portion, the protective layer having a corresponding outer marginal portion which is free of the sheet, after the outer marginal portion of the sheet is removed, for attaching the label to the package, the sheet including a first inner portion containing information arranged on a first side of the sheet and a second inner portion containing shipping address information arranged on the first side of the sheet, the first side of the sheet being disposed to face the package, wherein the second inner portion is removable from the protective layer, the second inner portion is capable of being reversed front-to-back and being re-attachable to the protective layer such that the shipping address information faces away from the package for displaying the shipping address information thereby.

2. The label as claimed in claim 1, wherein the information on the first inner portion is shipping slip information and the package is a shipping package.

3. The label as claimed in claim 1, wherein the information on the first inner portion is invoice information.

4. The label as claimed in claim 1, wherein the information on the first inner portion is customs information.

5. The label as claimed in claim 1, wherein the sheet has a second side opposite the first side of the sheet, the second side of the sheet being configured to enable the second inner portion to be removable from the protective layer.

6. The label as claimed in claim 1, wherein the sheet has a second side opposite the first side and wherein the label further includes a free radical silicone layer at least partially coating portions of the second side of the sheet, the free radical silicone layer enabling said portions of the sheet so coated to be removable from the protective layer.

7. The label as claimed in claim 1, wherein the portion of the protective layer that is transparent aligns with the second inner portion.

8. The label as claimed in claim 1, wherein the second inner portion has a first side and a second side opposite thereof, the second inner portion connecting to the protective layer via the first side of the second inner portion, and after being reversed front-to-back, the second inner portion being connectable to the protective layer via the second side of the second inner portion.

9. The label as claimed in claim 8, wherein the sheet is configured to enable the second inner portion to be removed from connecting to the protective layer via the first side of the second inner portion and configured to enable the second inner portion to re-attach to the protective layer via the second side of the second inner portion.

10. The label as claimed in claim 1, wherein the sheet further includes a removable third inner portion, the third inner portion containing return shipping address information arranged on the first side of the sheet, the third inner portion being configured to be reversible front-to-back so that the return shipping address information faces away from the package for displaying the return shipping address information thereby.

11. The label as claimed in claim 1, wherein the sheet further includes a removable third inner portion, the third inner portion being shaped to accommodate a business card, the protective layer having a corresponding transparent portion which is free of the sheet, after the third inner portion of the sheet is removed, for attaching the business card thereon.

12. The label as claimed in claim 1, wherein the sheet further includes a peel tag portion adjacent to the outer marginal portion of the sheet, the peel tag portion being disposed to be grasped by a user when the outer marginal portion of the sheet is being removed.

13. The label as claimed in claim 1 wherein the first inner portion is configured to be removable from the protective layer by an end user for safe keeping.

14. The label as claimed in claim 2, wherein the first inner portion further contains return shipping address information on a side of the first inner portion opposite of that containing the shipping slip information and wherein the portion of the protective layer that is transparent aligns with the first inner portion for displaying the return shipping address information.

15. The label as claimed in claim 2, wherein the first inner portion further contains advertising indicia on a side of the first inner portion opposite of that containing the shipping slip information, the portion of the protective layer that is transparent aligning with the first inner portion for displaying the advertising indicia.

16. The label as claimed in claim 6 wherein the sheet is direct thermal sheet paper, the protective layer is clear polypropylene, and the adhesive layer is hot melt, permanent adhesive.

17. A label for a package comprising:
a protective layer having at least a portion that is transparent;
an adhesive layer connected to a side of the protective layer; and
a sheet connected to the protective layer via the adhesive layer, the sheet including a removable outer marginal portion, the protective layer having a corresponding outer marginal portion which is free of the sheet, after the outer marginal portion of the sheet is removed, for attaching the label to the package, the sheet including a first inner portion containing information arranged on a first side of the sheet and a second inner portion containing shipping address information arranged on the first side of the sheet, the first side of the sheet being disposed to face the package, the second inner portion being removable from the protective layer for separately attaching the second inner portion to the package and displaying the shipping address information thereby.

18. The label as claimed in claim 17 further including a first part and a second part connected to the first part via perforations, the first part of the label including the outer marginal portion of the sheet and the first inner portion of the sheet, the second part of the label including the second inner portion of the sheet, the first part of the label being detachable from the second part of the label.

19. In combination, a shipping label for a shipping package and a business card for connecting to the shipping label, the label comprising:
a protective layer having at least a portion that is transparent;
an adhesive layer connected to a side of the protective layer; and
a sheet connected to the protective layer via the adhesive layer, the sheet including a removable outer marginal portion, the protective layer having a corresponding outer marginal portion which is free of the sheet, after the outer marginal portion of the sheet is removed, for attaching the label to the package, the sheet having a first inner portion containing information arranged on a first side of the sheet, the first side of the sheet being disposed to face the shipping label, and the sheet having a removable second inner portion shaped to accommodate the business card, the portion of the protective layer that is transparent being free of the sheet, after the second inner portion of the sheet is removed, for attaching the business card thereon.

20. The combination as claimed in claim 19, wherein the business card has address information on one side of the business card and wherein the business card connects to the protective layer such that the address information of the business card faces away from the package for displaying the address information of the business card.

21. A method of forming a shipping label for a shipping package, the method comprising:
providing a sheet having a first side for facing the package and a second side opposite the first side;
printing shipping slip information and shipping address information on the first side of the sheet;
separating the sheet into a removable outer marginal portion, a first inner portion containing the shipping slip information and a second inner portion containing shipping address information;
connecting a protective layer to the second side of the sheet via an adhesive, the protective layer having at least a portion that is transparent, the protective layer having an outer marginal portion which is free of the sheet, after the outer marginal portion of the sheet is removed, for attaching the label to the package;
configuring the second inner portion of the sheet to be removable from the protective layer; and
removing the second inner portion from the protective layer, reversing front-to-back the second inner portion, and re-connecting the second inner portion to the protective layer such that the shipping address information faces away from the package for displaying the shipping address information thereby.

22. The method as claimed in claim 21, wherein within the step of separating the sheet, the sheet is separated by cutting the sheet.

23. The method as claimed in claim 21 wherein, in the step of configuring, at least partially coating the protective layer with the adhesive and at least partially coating the sheet with a free radical silicone layer, and interposing the adhesive and the free radical silicone layer between the protective layer and the sheet.
